(19) United States
(12) Patent Application Publication
(10) Pub. No.: US 2026/0358166 A1
(43) Pub. Date: Nov. 12, 2026

(54) MODULAR MEASUREMENT SYSTEM AND METHOD FOR OPERATING AND/OR VERIFYING SAME

(71) Applicant: Endress+Hauser Flowtec AG, Reinach (CH)

(72) Inventors: Benjamin Schwenter, Ettingen (CH); Marc Werner, Grenzach-Wyhlen (DE); Peppino Breda, Liestal (CH); Michael Kirst, Lörrach (DE); Paul Penner, Herford (DE)

(21) Appl. No.: 19/137,916

(22) PCT Filed: Dec. 13, 2023
(86) PCT No.: PCT/EP2023/085597

§ 371 Date: Jun. 11, 2025

(30) Foreign Application Priority Data
Dec. 20, 2022 (DE) 10 2022 134 037.6
Mar. 31, 2023 (DE) 10 2023 108 373.2

(51) Int. Cl. G01F 25/10; G01F 1/84

(52) U.S. Cl. CPC G01F 25/10; G01F 1/8418; G01F 1/8422; G01F 1/8427; G01F 1/8431; G01F 1/8436; G01F 1/8477

(57) ABSTRACT

A modular measurement system for measuring a fluid medium includes: measurement system electronics; and a base module including: a housing having at least one chamber enclosed by a housing wall; a first electrical coil; and a second electrical coil at a distance from the first electrical coil, wherein the base module accommodates a vibronic module in the chamber and is connected to the vibronic module in a mechanically fixed yet detachable manner, and wherein, in a test mode when the vibronic module is absent from the chamber, the measurement system electronics are configured to perform a verification of the base module and/or of the measurement system electronics to inject a test driver signal into the first electrical coil and to capture and evaluate a test voltage from the second electrical coil, the test voltage being inductively coupled from the first electrical coil into the second electrical coil.

The invention relates to a modular measurement system, in particular a Coriolis mass flow meter, and to a method for commissioning and/or checking/testing a vibronic measurement system, in particular a modular Coriolis mass flow meter.

WO 2019/017891 A1 or WO 2021/121867 A2 as well as the German patent applications DE 102021105397A1, DE102020133614A1, DE 102020132685A1, DE 102020133851 A1, DE 102020133566A1, DE 102020132986A1, DE 102020132686A1, DE 102020132685A1, DE 102020131452A1, DE 102020132223A1, DE 102020127356 A1, DE 102020114519A1, or DE 102020112154 A1 in each case disclose modular vibronic measurement systems, specifically those formed by means of a base module, a vibronic module mechanically connected to the base module, and measurement system electronics electrically connected to the base module and used to detect at least one measurement variable of a fluid medium flowing in a (medium) line, specifically to determine measured values for one or more measurement variables, e.g., a mass flow, a volume flow, a density, and/or a viscosity, of the medium.

The base module of such a (modular) vibronic measurement system has a (protective) housing with at least one chamber at least partially enclosed by a housing wall and one or more electrical coils, e.g., cylindrical and/or designed as air coils, which are placed (at a distance from each other) inside the chamber of the (protective) housing and are at least indirectly mechanically connected to the housing wall. Each of the coils is also electrically connected to the measurement system electronics. The measurement system electronics can be housed at least partially inside the (protective) housing and/or at least partially outside the (protective) housing—for example, in a separate electronics housing. In particular, the base module is also configured to receive the vibronic module of the measurement system and to be connected thereto in a mechanically fixed (forming a vibration-type transducer), yet detachable manner, in particular to form the vibronic measurement system itself; this is also done in particular in such a manner that the vibronic module is locked in the base module or cannot be moved.

The vibronic module of the respective measurement system is also designed to be replaceable, in such a manner that it can be inserted into the chamber, in particular also on site, from outside the (protective) housing of the base module or through an (insertion) opening of the housing provided in the housing wall, and that it can be removed from the base module again in a non-destructive manner, possibly also without tools, in particular, viz., from outside the housing and/or can be removed through the (slide-in) opening of the housing or without the base module itself having to be handled or removed from the (process) plant. This also makes it possible, among other things, to insert a vibronic module subsequently on site, i.e., into an already installed base module, or to replace a defective or worn vibronic module on site with an intact, new vibronic module, which may be used only once or only for a specified period of time (“disposable”). The vibronic module furthermore has one or more, e.g., cylindrical, permanent magnets and is furthermore configured to be installed in the base module in such a manner that each of the permanent magnets is placed within the aforementioned chamber, but is nevertheless spaced apart from the housing wall, in particular in such a manner that each of the permanent magnets is held in a static installation position predetermined in each case with respect to an alignment and/or a smallest distance from one of the electrical coils of the base module, and that a respective imaginary longitudinal axis of each of the permanent magnets and an imaginary longitudinal axis of at least one of the electrical coils are aligned with one another or run parallel to one another in extension.

In the measurement systems in question, each vibronic module further has at least one (measurement) tube, e.g., at least partially straight and/or at least partially curved, with a tube wall forming an outer shell surface of the tube, in particular made of a metal or a plastic, and with a lumen enclosed by the same tube wall, in particular two, essentially identical, parallel (measurement) tubes, and each of the aforementioned permanent magnets is mounted on the outside of the tube wall, in particular at a first segment end and a second segment end, viz., two, essentially identical, parallel (measurement) tubes, and each of the aforementioned permanent magnets is fixed to the outside of the tube wall, in particular to a central segment of the tube wall extending between a first segment end and a second segment end remote therefrom, in particular is connected to the tube wall by means of a material bond. In addition, the vibronic module or its at least one (measurement) tube is designed to be installed in the housing, if necessary without tools, in such a manner that the tube is placed at least partially, in particular completely, within the chamber, but is nevertheless spaced from the housing wall, and that each of the permanent magnets in the respective installation position together with the respective electrical coil form a voice coil, in particular serving as an electrodynamic vibration exciter, and/or a plunger coil, in particular serving as an electrodynamic vibration sensor. In the case of a (measurement) tube that is bent at least in portions, the aforementioned central segment can, for example, be substantially U-shaped or V-shaped.

In such a vibronic measurement system, each of the above-mentioned (measurement) tubes is also configured to carry a fluid medium flowing within the lumen during operation, in particular with a predeterminable flow direction and/or flow direction pointing from the first segment end to the second segment end, and to be vibrated in the meantime in order to generate measuring effects correlated with one or more measurement variables of the medium, in particular in such a manner that the central segment performs oscillating movements about a static rest position and/or that the (measurement) tube is driven by means of at least one of the aforementioned (energized) voice coils and/or that a (measurement) voltage representing oscillating movements of the at least one tube and thus serving as an oscillation signal is generated by means of the aforementioned plunger coils. The measurement system electronics of such a measurement system is in turn configured accordingly, by means of an electrical driver signal, in particular with an impressed alternating current and/or an impressed (alternating current) frequency substantially corresponding to a resonant frequency of the at least one tube, to feed electrical power into the at least one electrical coil forming the aforementioned voice coil, and/or, by means of the (measurement) voltage generated by the at least one electrical coil forming the aforementioned plunger coil, to determine measurement values for the one or more measurement variables to be detected for the medium flowing through the (measurement) tube or tubes, in the case of a measuring apparatus designed as a Coriolis mass flow meter or measuring apparatus designed as a Coriolis mass flow/density measuring apparatus, for example, specifically to generate (mass flow) measured values representing the mass flow on the basis of a (measured) phase difference, caused by Coriolis forces in the medium flowing through the oscillating tube, between two of the aforementioned oscillation signals and a phase difference-to-measured value characteristic function configured in the measurement system electronics. The phase difference-to-measured mass flow characteristic function can, for example, be a (linear) parameter function with a (scale) zero point that corresponds to a (measured) phase difference of the two oscillation signals that can be measured when the medium is at rest or when the mass flow is zero, and with a slope which corresponds to a (measurement) sensitivity of the measurement system or a change in the (measurement) phase difference related to a change in the mass flow. Since one or more resonance frequencies of the at least one tube are particularly also dependent upon the instantaneous density of the respective medium, by means of such a measurement system, in addition to the mass flow, the density of the respective medium flowing through it can also be measured directly by means of the (alternating current) frequency of the driver signal and/or by means of a (signal) frequency of at least one of the oscillation signals. Accordingly, the measurement system electronics of measurement systems of the type in question are typically further equipped to generate (density) measured values representing the density on the basis of the aforementioned (alternating current) frequency of the driver signal and/or on the basis of a corresponding signal frequency of at least one of the oscillation signals—for example, using a characteristic curve function configured accordingly in the measurement system electronics. Furthermore, it is also possible to directly measure the viscosity of the medium flowing through by means of vibronic measurement systems of the type in question, for example, based upon an excitation energy or excitation power required to maintain the useful oscillations and/or based upon a damping of the excited (resonance) oscillations resulting from a dissipation of oscillation energy or by using a damping-to-measurement characteristic curve function set up accordingly in the measurement system electronics. In addition, further measurement variables derived from the aforementioned flow and/or substance parameters, such as the Reynolds number, can be easily determined by means of such vibronic measurement systems.

To simplify the commissioning of a measurement system formed in this manner, the vibronic module may further have at least one identifying element relating to or carrying identifying information about the vibronic module, e.g., a barcode, QR code, or RFID label attached to at least one tube, and/or the base module can have at least one light-emitting semiconductor element positioned inside the (protective) housing and connected to the measurement system electronics, e.g., a light-emitting diode (LED), and/or one or more radio transmitters/receivers (RF transceivers) and/or photosensors, e.g., one or more CCD photosensors and/or one or more CMOS photosensors, each positioned inside the (protective) housing and connected to the measurement system electronics.

Vibronic measurement systems of the type in question must also be regularly checked for their functional efficiency or any deviations from a respective reference state determined in advance, e.g., in the state determined by the manufacturer or in the manufacturer's factory and/or during a calibration or commissioning of the respective measurement system on site, e.g., in order to be able to detect as early as possible any reductions in the functionality or measuring accuracy of the measurement system associated with increased deviations from the reference state, with which the measurement system ultimately maps the measurement variable to be detected, not least the mass flow and density, into the corresponding measured values. Such reductions in the functionality or measuring accuracy of such a measurement system can occur, for example, in the form of mostly irreversible changes in the electrical impedance of the above-mentioned swing and/or immersion coils and/or a permanently reduced stability of the mechanical connection between the base module and the vibronic module or the precision of the positioning of the vibronic module in the base module, or can be caused, for example, by thermal and/or mechanical overloads, approximately as a result of very high or very low temperatures within the base module, aging, increased or condensing moisture within the base module, and/or wear of components of the base module caused by frequent replacement of vibronic modules. Other influencing factors that at least indirectly and/or at least temporarily impair the functionality of the measurement system include multi-frequency and/or high-frequency electromagnetic (external) radiation or fields (EMC) propagating within the base module or (external) sound waves propagating within the base module⇒for example, in the form of structure-borne sound.

As a result, it must regularly be assumed that one or more of the system functions (transfer functions) inherent in the measurement system, each of which characterizes a functional dependence of the aforementioned vibration signals upon the respective driver signal or one or more functional dependencies of the vibration signals upon the driver signal and the respective flow and/or material parameters of the medium, is also changed in comparison to a (reference) system function inherent in the respective original transducer. Examples of such system functions of the measurement system include a mass flow-to-phase difference system function, in accordance with which the aforementioned (measurement) phase difference of the oscillation signals is dependent upon the mass flow, or a density-to-resonance frequency system function of the transducer, in accordance with which one or more resonance frequencies of the at least one tube are dependent upon the density of the medium. Equally affected by such (over)loading of the transducer are accordingly also the measuring functions of the measurement system involving the aforementioned system functions, in accordance with which the measurement system as a whole converts the respective measurement variable to be recorded into the respective measured values, e.g., a characteristic curve function composed of the aforementioned mass flow-to-phase difference system function and a phase difference-to-mass flow measured value characteristic curve function, viz., a characteristic function implemented in the measurement system electronics, in accordance with which a determined phase difference is converted into mass flow measured values, mass flow-to-measured value measuring function of the measurement system, in accordance with which mass flow measured values determined thereby are dependent upon the mass flow. The phase difference-to-mass flow measurement characteristic curve function can, for example, be a (linear) parameter function with a (scale) zero point corresponding to a (measurement) phase difference measured when the medium is at rest and a (measurement) sensitivity corresponding to a change in the (measurement) phase difference related to a change in the mass flow (slope of the characteristic curve function). Further examples of such system functions that are also potentially affected by interference or measurement functions formed with them include a density-to-resonant-frequency system function of the transducer or a density-to-measured value (measurement) function of the measurement system involving this and a resonant-frequency-to-density measured value characteristic function of the measurement system electronics and/or a viscosity-to-damping system function of the transducer or a viscosity-to-measured-value (measurement) function of the measurement system involving this and a damping-to-viscosity measured-value characteristic function of the measurement system electronics. The change in the respective system function can accordingly have an effect, for example, as a drift of one or more of the respective characteristic curve parameters of one or more of the aforementioned characteristic curve functions-in the case of a linear parameter function, for example, of its zero point and/or its slope. The aforementioned, possibly also irreversible changes to one or more of the system or measuring functions of the measurement system can occasionally also lead to the measurement system as a whole working incorrectly to such an extent that the high measuring accuracy typically aimed for in such measurement systems is no longer guaranteed, meaning that the functionality of the measurement system is considerably impaired, possibly even suspended, or that there is a correspondingly critical malfunction of the affected measurement system.

Taking this into account, measurement systems of the type in question are typically subjected to corresponding (re-)inspections, e.g., at regular intervals in the course of regular predictive maintenance; this in particular also in such a manner that the functionality of the vibronic module or the totality of the measurement system is checked on site in the course of a time-controlled (self-)diagnosis carried out by means of the measurement system and/or triggered by corresponding control commands transmitted to the measurement system electronics, approximately in order to be able to initiate appropriate repair or replacement measures as quickly as possible if necessary, not least when a malfunction of the measurement system is detected. In the case of a vibronic measurement system of the type in question, such a (repair or replacement) measure regularly involves replacing the defective vibronic module with a new vibronic module, which can also be carried out quickly and easily on site. However, one disadvantage of a test procedure in such a manner is that only the functionality of the measurement system as a whole can be verified or, conversely, that any malfunction detected cannot be localized exactly within the measurement system, i.e., assigned to the base module, the vibronic module, or the measurement system electronics. In particular, it is not readily possible with such a (self-)diagnosis to identify malfunctions of the base module or the measurement system electronics electrically connected to it which merely impair the measuring accuracy, in such a manner that a need to replace the base module and/or the measurement system electronics can also be determined in the course of such a check of a measurement system of the type in question.

Based upon the aforementioned prior art, one object of the invention is to improve the checking of modular vibronic measurement systems in such a manner that any malfunctions or defects of the base module and/or the measurement system electronics, not least also signs of wear or aging of the base module or the measurement system electronics which reduce the measuring accuracy of the measurement system as a whole, can be detected as early and reliably as possible and, if necessary, also reported.

The object is achieved by the modular measurement system according to the invention, in particular a Coriolis mass flow meter, for measuring a measurement variable of a fluid medium, which measurement system comprising:
a measurement system electronics (ME);
a base module (M1), said base module (M1) having:
   a (protective) housing with at least one chamber at least partially enclosed by a ho using wall,
   at least one first electrical coil which is placed inside the chamber of the (protective) housing, is in particular cylindrical and/or designed as an air coil, and is at least indirectly mechanically connected to the housing wall and electrically connected to the measurement system electronics (ME), and
   at least one second electrical coil which is in particular placed within the chamber of the (protective) housing, is in particular cylindrical and/or designed as an air coil and/or is identical in construction to the first electrical coil, and which is positioned in particular at a distance from the first electrical coil, and is at least indirectly mechanically connected to the housing wall, and is electrically connected to the measurement system electronics (ME);
wherein the base module (M1) is configured to receive a vibronic module (M2) of the measurement system, in particular in the chamber, and to be connected thereto in a mechanically fixed, yet detachable manner, in particular by forming a measuring sensor of the vibration type or a vibronic measurement system and/or in such a manner that the vibronic module (M2) is locked in the base module (M1) or cannot be moved, and
wherein, in a measuring mode when the vibronic module (M2) is present in the chamber, the measurement system electronics (ME) are configured to feed a (measurement) driver signal into the first electrical coil to excite vibrations of the vibronic module (M2) as well as to detect and evaluate an electrical (measurement) voltage induced in the second electrical coil by vibrations of the vibronic module (M2) from the second electrical coil, in particular to determine measured values for the at least one measurement variable,
and wherein, in a test mode when the vibronic module (M2) is absent from the chamber, in particular also when other mobile magnetic field-generating devices are absent, specifically devices not belonging to the base module (M1), the measurement system electronics (ME) are designed to perform a check, in particular a (re-)calibration, of the base module (M1) and/or of the measurement system electronics (ME), specifically when the vibronic module (M2) is absent, both to feed a (first) (test) driver signal into the first electrical coil and to capture and evaluate an electrical (test) voltage from the second electrical coil, said (test) voltage being in particular inductively coupled from the first electrical coil into the second electrical coil, in particular to compare at least one parameter of the (test) voltage, in particular an amplitude and/or a frequency and/or a phase angle and/or a measured value of an inductance with a previously determined reference value and/or with a specified threshold value.

In the test mode, neither a vibronic module nor a test module according to one of the (not pre-published) DE 102021126587.8, DE 102022134029.5, or DE 102022100234.9 or other external magnetic-field generating devices that are not part of the base module or the measurement system electronics are arranged in the chamber of the base module.

One embodiment provides that the measurement system electronics be configured to feed electrical power into the first electrical coil by means of the electrical (measurement system) driver signal and/or the (first) (test) driver signal, in particular with an impressed alternating current.

One embodiment provides that the measurement system electronics (ME) be configured to feed the (first) (test) driver signal with at least two different frequencies, in particular with a resonance frequency of the (protective) housing, a nominal resonance frequency of the vibronic module (M2), and/or a mains frequency.

One embodiment provides that, in the test mode, the measurement system electronics (ME) also be configured to feed electrical power into the second electrical coil by means of a (second) electrical (test) driver signal, in particular with an impressed alternating current.

One embodiment provides that the measurement system electronics (ME) also be configured, in the test mode, to detect and evaluate an electrical (test) voltage, which is, in particular by means of the second coil, inductively coupled into the first electrical coil or induced in the first electrical coil, in particular using the (test) voltage to determine at least one parameter of the (test) voltage, in particular an amplitude and/or a frequency and/or a phase angle and/or a measured value of an inductance, and to compare said parameter with a previously determined reference value and/or with a specified threshold value.

One embodiment provides that the measurement system electronics be configured, in the test mode, to determine an inductance, in particular of the first electrical coil, on the basis of the (test) voltage, in particular to compare the determined inductance with a previously determined (inductance) reference value and/or one or more threshold values specified therefor; and/or the measurement system electronics be configured to determine, in particular digital, measured values for at least one parameter of the (test) voltage, in particular an amplitude, a frequency, and/or a phase angle, on the basis of the (test) voltage, in particular to compare the measured values with a previously determined reference value and/or one or more threshold values specified therefor.

One embodiment provides that the base module have at least one third electrical coil which is in particular placed within the chamber of the (protective) housing, is in particular cylindrical and/or designed as an air coil, and/or is identical in construction to the second electrical coil, and which, positioned in particular at a distance from the second electrical coil, is in particular at least indirectly mechanically connected to the housing wall; and the third electrical coil be electrically connected to the measurement system electronics.

One embodiment provides that the measurement system electronics be configured, in the test mode, to feed electrical power into the third electrical coil by means of a (third) electrical (measurement) driver signal, in particular with an impressed alternating current.

One embodiment provides that the measurement system electronics (ME) be configured, in the test mode, to detect and evaluate an electrical (test) voltage, which is, in particular by means of the first electrical coil and/or the second electrical coil, inductively coupled into the third electrical coil or induced in the third electrical coil, in particular using the (test) voltage for at least one parameter of the (test) voltage, in particular to determine an amplitude and/or a frequency and/or a phase angle and/or an inductance.

One embodiment provides that, in the test mode, the measurement system electronics (ME) be configured to detect and evaluate electrical (test) voltages, which are in particular, by means of the first electrical coil, inductively coupled into the second electrical coil and the third electrical coil or induced in the second electrical coil and in the third electrical coil, in particular using the (test) voltages for at least one parameter of the (test) voltages, in particular to determine in each case an amplitude and/or a frequency and/or a phase angle and/or an inductance and/or a phase difference between the (test) voltage detected at the second coil and the (test) voltage detected at the third coil.

One embodiment provides that, in the test mode, the measurement system electronics (ME) be configured to detect and evaluate an electrical (test) voltage from the first electrical coil and/or the second electrical coil, which voltage is, in particular by means of the third electrical coil, inductively coupled into the first electrical coil and/or the second electrical coil or induced in the first electrical coil and/or the second electrical coil, in particular using the (test) voltage for at least one parameter of the (test) voltage, in particular to determine an amplitude and/or a frequency and/or a phase angle and/or an inductance.

One embodiment provides that, in the test mode, the measurement system electronics (ME) be configured to provide the (first) electrical (test) driver signal, the (second) electrical (test) driver signal, and/or the (third) electrical (test) driver signal with a mechanical resonance frequency, in particular first mechanical resonance frequency and/or second mechanical resonance frequency, of the vibronic module corresponding signal frequency.

One embodiment provides that the vibronic module have at least one, in particular cylindrical, first permanent magnet, wherein the vibronic module is configured to be installed in the base module in such a manner that its first permanent magnet is placed inside the chamber, but is nevertheless spaced apart from the housing wall, in particular in a static (first) installation position which is specified with respect to an orientation and/or a smallest distance from the first electrical coil and/or held with the static (first) installation position, and/or in such a manner that an, imaginary longitudinal axis of the first permanent magnet and an imaginary longitudinal axis of the first electrical coil are aligned with one another or extend parallel to one another as an extension.

One embodiment provides that the third electrical coil be part of the measurement system electronics.

One embodiment provides that the third electrical coil be designed to be spatially displaceable.

One embodiment provides that the measurement system electronics be configured to determine and evaluate measured values for a coil current or variables dependent thereon, in particular to compare one or more (parameter) measured values for the coil current or variables dependent thereon with a previously determined (coil current) reference value and/or one or more (coil current) threshold values specified for this purpose.

One embodiment provides that the measurement system electronics be configured to determine and evaluate measured values for a signal strength of the (test) driver signal, in particular to compare one or more measured values for the signal strength of the (test) driver signal with a previously determined (signal strength) reference value and/or one or more (signal strength) threshold values specified for this purpose.

One embodiment provides that the measurement system electronics be configured to determine and evaluate a signal curve of the driver signal over time.

The method according to the invention for commissioning and/or checking/testing a vibronic measurement system, in particular a modular Coriolis mass flow meter, comprising:
which measurement system has
a base module (M1) having
   a (protective) housing with at least one chamber at least partially enclosed by a housing wall;
   as well as at least one first electrical coil which is placed inside the chamber of the (protective) housing, in particular cylindrical and/or designed as an air coil, and which is at least indirectly mechanically connected to the housing wall and electrically connected to the measurement system electronics,
and a vibronic module, in particular a vibronic module in accordance with claim 13;
wherein the base module is configured to receive the vibronic module and to be connected thereto in a mechanically fixed, yet detachable manner, in particular by forming a measuring sensor of the vibration type or a vibronic measurement system and/or in such a manner that the vibronic module (M2) is not movable or is locked in the base module (M1);
   which method comprises:
checking or (re-)calibrating the base module (M1) and/or the measurement system electronics (ME) during a test mode, by means of the measurement system electronics in the absence of the vibronic module (M2) in the chamber, in particular also in the absence of further mobile magnetic field generating devices not belonging to the base module (M1), in particular by feeding a (first) (test) driver signal into the first electrical coil and by detecting and evaluating an electrical (test) voltage from the second electrical coil, which voltage is in particular inductively coupled from the first electrical coil into the second electrical coil, in particular by comparing at least one parameter of the (test) voltage, in particular an amplitude and/or a frequency and/or a phase angle and/or a measured value of the self-inductance, with a previously determined reference value and/or with a specified threshold value;
inserting a vibronic module (M2), in particular a vibronic module in accordance with claim 13, into the base module (M1) to form a vibration-type measuring sensor or the vibronic measurement system; and
determining measured values for the at least one measurement variable during the measuring mode by feeding a (measurement) driver signal into the first electrical coil to excite vibrations of the vibronic module (M2) and detecting an electrical (measurement) voltage from the second electrical coil, which voltage is induced in the second electrical coil by vibrations of the vibronic module (M2).

According to one embodiment, it is further provided that the base module have at least one second electrical coil which is placed within the chamber of the (protective) housing, and which is, for example, cylindrical and/or designed as an air coil and/or identical in construction to the first electrical coil, and which, positioned in particular at a distance from the first electrical coil, is at least indirectly mechanically connected to the housing wall, and that the second electrical coil be electrically connected to the measurement system electronics. In this embodiment of the invention, the measurement system electronics are further configured to feed electrical power into the first electrical coil by means of an electrical (measurement) driver signal, for example with an impressed alternating current, and to feed electrical power into the second electrical coil by means of a (first) electrical (test) driver signal—for example, with an impressed alternating current. Alternatively or in addition, the measurement system electronics can further be configured to detect and evaluate an electrical (test) voltage from the second electrical coil or from the third electrical coil, which voltage is for example inductively coupled from the first electrical coil into the second electrical coil or induced in the third electrical coil, for example, specifically using the (test) voltage to determine (parameter) measured values for an amplitude and/or a frequency and/or a phase angle and/or another parameter of the (test) voltage and/or an inductance, in particular of the first and/or second electrical coil and/or measured values for at least one measurement variable of a flowing fluid, and/or the measurement system electronics can also be configured to detect and evaluate an electrical (test) voltage from the third electrical coil, which voltage is for example inductively coupled from a first electrical coil of the base module into the third electrical coil or induced in the third electrical coil, for example, specifically using the (test) voltage to determine (parameter) measurement values for an amplitude and/or a frequency and/or a phase angle and/or another parameter of the (test) voltage and/or an inductance, in particular of the first and/or third electrical coil and/or measurement values for at least one measurement variable of a flowing fluid, and/or the measurement system electronics can furthermore also be configured to determine a phase difference established between the (test) voltages—for example, in order to use it to determine measurement values for a mass flow and/or another measurement variable of a flowing fluid. Furthermore, the measurement system electronics can be further configured to compare one or more of the (parameter) measured values with a (parameter) reference value determined in advance and/or one or more specified threshold values.

According to one embodiment, the base module is configured to receive a vibronic module of the measurement system and to be connected thereto in a mechanically fixed, yet detachable manner, in particular by forming a measuring sensor of the vibration type or a vibronic measurement system and/or in such a manner that the vibronic module is locked in the base module or cannot be moved. This embodiment of the invention further provides that the base module have at least one (first) electrical coil placed within the chamber of the (protective) housing, e.g., cylindrical and/or designed as an air coil, which is at least indirectly mechanically connected to the housing wall and subsequently electrically connected to the measurement system electronics, and that the measurement system electronics be further configured to feed electrical power into the first electrical coil by means of a first electrical (measurement) driver signal, e.g., with an impressed alternating current, e.g., viz., the (first) electrical (measurement) driver signal with a signal frequency corresponding to a mechanical resonance frequency of the vibronic module, and/or it is provided that the vibronic module have at least one, in particular cylindrical, first permanent magnet. Further, the vibronic module may be further configured to be installed in the base module in such a manner that the aforementioned (first) permanent magnet (of the vibronic module) is placed within the chamber, yet spaced from the housing wall, e.g., is held in a static (first) installation position which is specified and/or with respect to an alignment and/or a minimum distance from the aforementioned (first) electrical coil (of the base module) and/or in such a manner that an imaginary longitudinal axis of the (first) permanent magnet and an imaginary longitudinal axis of the (first) electrical coil are aligned with one another or extend parallel to one another as an extension. According to the invention, however, the calibration is carried out in the absence of the vibronic module, i.e., the vibronic module is not arranged in the chamber of the base module at the time of calibration.

According to one embodiment, the base module is configured to receive a vibronic module of the measurement system and to be connected thereto in a mechanically fixed, yet detachable manner, e.g., by forming a measuring sensor of the vibration type or a vibronic measurement system and/or in such a manner that the vibronic module is locked in the base module, wherein the vibronic module (of the measurement system) has at least one (first) tube, e.g., at least partially straight and/or at least partially curved, with a tube wall forming an outer shell surface of the tube, e.g., made of a metal or a plastic, and with a lumen enclosed by the same tube wall, and wherein the vibronic module is configured, e.g., without tools, to be installed in the (protective) housing (of the base module) in such a way that the at least one tube is placed at least partially or completely within the chamber, but is nevertheless spaced apart from the housing wall. This embodiment of the invention further provides that the first tube be designed to be U-shaped or V-shaped at least in sections and/or be configured to guide a fluid medium flowing in its lumen, in particular with a predeterminable flow direction and/or a flow direction pointing from a first segment end (on the inlet side) to a second segment end (on the outlet side), and/or to guide the medium and to vibrate it in the process. Alternatively or additionally, the vibronic module can also have at least one second tube, e.g., of the same construction and/or function as the first tube, with a tube wall forming an outer shell surface of the second tube, e.g., made of a metal or a plastic or of the same material as the tube wall of the first tube, and with a lumen enclosed by the same tube wall—for example, with a second permanent magnet fixed to the outside of the tube wall.

According to one embodiment, the base module is configured to receive a vibronic module of the measurement system and to be connected thereto in a mechanically fixed, yet detachable manner, e.g., by forming a measuring sensor of the vibration type or a vibronic measurement system and/or in such a manner that the vibronic module is locked in the base module, wherein the vibronic module (of the measurement system) comprises at least one (first) tube, e.g., at least partially straight and/or at least partially curved, with a tube wall forming an outer shell surface of the tube, e.g., made of a metal or a plastic, and with a lumen enclosed by the same tube wall, and at least one, e.g., cylindrical, first permanent magnet which is fixed on the outside of the tube wall, e.g., on a central segment of the tube wall extending between a first segment end and a second segment end remote therefrom, e.g., is connected to the tube wall by a material bond, and wherein the vibronic module is configured, e.g., without tools, to be installed in the (protective) housing (of the base module) in such a way that the at least one tube is placed at least partially or completely within the chamber, but is nevertheless spaced apart from the housing wall. This embodiment of the invention further provides that the base module have at least one (first) electrical coil placed within the chamber of the (protective) housing, e.g., cylindrical and/or designed as an air coil, which is at least indirectly mechanically connected to the housing wall and subsequently electrically connected to the measurement system electronics, and/or that the vibronic module be configured to be installed in the base module in such a manner that the aforementioned (first) permanent magnet (of the vibronic module) is placed inside the chamber, but is nevertheless spaced apart from the housing wall, e.g., is held in a static (first) installation position which is specified and/or with respect to an alignment and/or a smallest distance to the aforementioned (first) electrical coil (of the base module) and/or in such a manner that an imaginary longitudinal axis of the (first) permanent magnet and an imaginary longitudinal axis of the (first) electrical coil are aligned with one another or extend parallel to one another in extension. For example, the (first) permanent magnet (of the vibronic module) can also be configured to form, in the installed position together with the first electrical coil (of the base module), a voice coil, in particular serving as an electrodynamic vibration exciter, and/or a plunger coil, in particular serving as an electrodynamic vibration sensor. Further, the (first) tube can be configured to have a fluid medium flowing through it and to be vibrated in the meantime, e.g., driven by an oscillation exciter formed by means of the first electrical coil and the first permanent magnet, e.g., in such a manner that at least the aforementioned central segment of the tube wall performs oscillation movements about a static rest position or that a (measurement) voltage induced in the (first) electrical coil represents oscillation movements of the (first) tube. Using the first (measurement) voltage measurement values, the measurement system electronics can, for example, also determine measurement values for at least one measurement variable of the medium flowing through the first tube. Furthermore, the vibronic module can have a second permanent magnet (remote from the first permanent magnet) fixed to the first tube, e.g., its central segment, and in particular connected to it by a material bond.

According to one embodiment, the base module has at least one second electrical coil which is placed within the chamber of the (protective) housing, e.g., cylindrical and/or designed as an air coil and/or identical in construction to the first electrical coil, and which, positioned in particular at a distance from the first electrical coil, is at least indirectly mechanically connected to the housing wall, the second electrical coil is electrically connected to the measurement system electronics, and the base module is further configured to receive a vibronic module of the measurement system and to be connected thereto in a mechanically fixed, yet detachable manner, e.g., by forming a measuring sensor of the vibration type or a vibronic measurement system and/or in such a manner that the vibronic module is locked in the base module, built into the base module, to be inserted into the base module, in particular from outside the housing and/or through an (insertion) opening of the (protective) housing provided in the housing wall. This embodiment of the invention further provides that the vibronic module have a first permanent magnet, e.g., cylindrical, and at least one second permanent magnet, e.g., cylindrical and/or identical in construction to the first permanent magnet, e.g., a second permanent magnet and a third permanent magnet. Further, the vibronic module may be configured to be installed in the base module such that the (first) permanent magnet (of the vibronic module) is placed within the chamber, but is nevertheless spaced from the housing wall, e.g., in a static first apparatus position which is specified with respect to an orientation and/or a smallest distance to the first electrical coil (of the base module) and/or held with the (first) installation position, and/or in such a manner that an, imaginary longitudinal axis of the first permanent magnet and an imaginary longitudinal axis of the first electrical coil are aligned with one another and/or extend parallel to one another, and/or the vibronic module can also be configured to be installed in the base module in such a manner that the second permanent magnet (of the vibronic module) is placed inside the chamber, but is nevertheless spaced apart from the housing wall, e.g., viz., in a static second installation position which is predetermined with respect to an alignment and/or a smallest distance from the second electrical coil (of the base module) and/or is remote from the first installation position and/or with the, and/or in such a manner that an, imaginary longitudinal axis of the second permanent magnet and an imaginary longitudinal axis of the second electrical coil are aligned with one another or extend parallel to one another as an extension.

According to a further development of the method of the invention, this further comprises integrating the test arrangement into a superordinate electronic data processing system. The data processing system can also be formed, for example, by means of a programmable logic controller (PLC) and/or by means of a process control system (PCS) and/or by means of an edge (computing) device and/or by means of a cloud (computing) system.

The basic idea of the invention is to carry out a test or (re-)calibration of the base module and/or the measurement system electronics without the vibronic module (or a test module) being arranged in the base module or in the chamber of the base module, and thus being able to influence the (re-)calibration. Especially if there are defects on the vibronic module which occurred during transport, for example, this can lead to errors when the base module and/or the measurement system electronics are calibrated for the first time with the vibronic module plugged in. However, it is not clear whether the origin of the error lies in the vibronic module or the base module. By (re-)calibrating the Coriolis mass flow meter, in particular the base module and/or the measurement system electronics in the absence of the vibronic module, a measurement error can be clearly attributed to the base module and/or the measurement system electronics.

The invention as well as advantageous embodiments thereof are explained in more detail below based upon exemplary embodiments shown in the figures of the drawing. Identical or identically acting or identically functioning parts are provided with the same reference signs in all figures; for reasons of clarity or if it appears sensible for other reasons, reference signs mentioned before are dispensed with in subsequent figures. Further advantageous embodiments or developments, especially, combinations of partial aspects of the invention that were initially explained only separately, furthermore emerge from the figures of the drawing and/or from the claims themselves.

Shown, in detail, are:

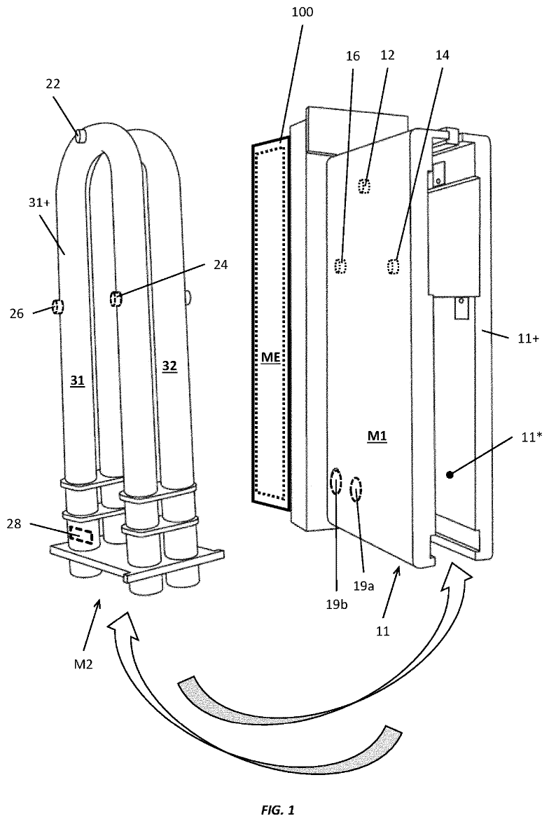

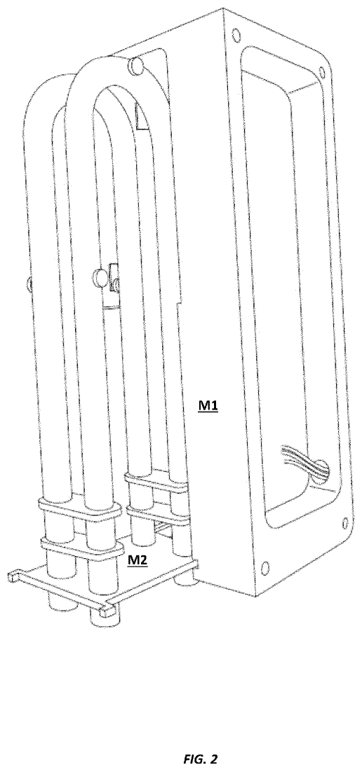

FIGS. 1, 2 an exemplary embodiment of a base module, measurement system electronics, and a vibronic module of a modular vibronic measurement system (still to be constructed/not yet assembled);

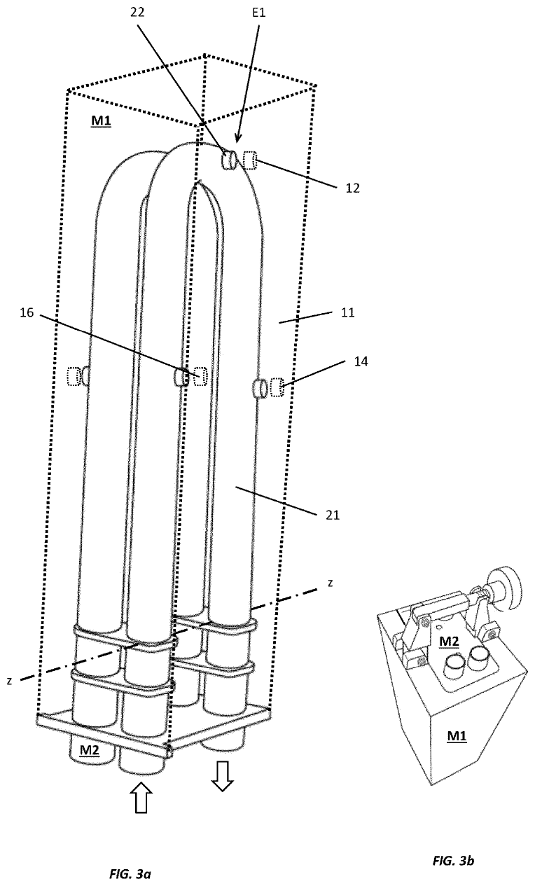

FIGS. 3a, 3b various side views of an exemplary embodiment of the modular vibronic measurement system according to FIG. 1;

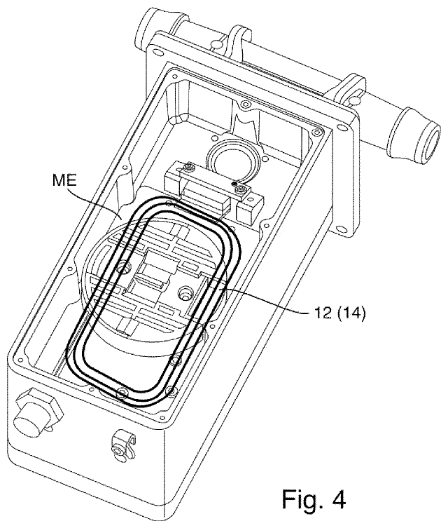

FIG. 4 an exemplary embodiment of a base module of measurement system electronics.

FIGS. 1, 2, 3a, and 3b schematically show an exemplary embodiment of a (modular) vibronic measurement system which is intended in particular to detect at least one measurement variable of a fluid medium flowing in a (medium) line, viz., to determine measured values for one or more measurement variables, e.g., a mass flow, a volume flow, a density, and/or a viscosity, of the medium. For this purpose, the measurement system comprises a base module M1, a vibronic module M2, and, for example, programmable measurement system electronics ME.

The measurement system electronics ME can, for example, be formed by means of one or more microprocessors (μC) and/or have a display and operating element, e.g., formed by means of a touch display—for example, for displaying measurement and/or operating data of the measurement system.

The base module M1 has a (protective) housing 11 with at least one chamber 11* at least partially enclosed by a housing wall 11+ and at least one first electrical coil 12, e.g., cylindrical and/or designed as an air coil, which is placed inside the chamber 11* of the (protective) housing and is at least indirectly mechanically connected to the housing wall 11+ and electrically connected to the measurement system electronics ME, and the vibronic module M2 has at least one, e.g., cylindrical, first permanent magnet 22. The measurement system electronics ME can, as is quite common in measurement systems of the type in question, also be housed at least partially within the chamber 11* and/or at least partially outside the chamber 11*, in particular within an electronics housing 100 of the measurement system, or be designed in a modular manner. The measurement system can, for example, be designed as a modular Coriolis mass flow meter and/or correspond to one of the vibronic measurement systems disclosed in the patent applications mentioned at the beginning WO 2019/017891A1, WO 2021121867A1, DE 102021105397A1, DE 102020133614A1, DE 102020132685A1, DE 102020133851 A1, DE 102020133566A1, DE 102020132986A1, DE 102020132686A1, DE 102020132685A1, DE 102020131452A1, DE 102020132223A1, DE 102020127356 A1, DE 102020114519A1, and DE 102020112154A1 .

The base module M1 is, as shown schematically in FIGS. 3a and 3b or as can be seen from a combined view of FIGS. 1, 2, 3a, and 3b without further ado, configured in particular to receive the vibronic module M2 and to be connected thereto in a mechanically fixed, yet detachable manner, e.g., in such a manner that the vibronic module M2 is locked in the base module M2, and/or in such a manner that the vibronic module can also be (subsequently) inserted on site, viz., in a base module already installed (in a plant). In particular, the base module M1 and the vibronic module M2 are further configured to be constructed or assembled to form a vibration-type measuring sensor (of the measurement system) so that an electro-mechanical vibration exciter and/or an (electro-dynamic) vibration sensor of the measurement system is formed by means of the electrical coil 12 (connected to the measurement system electronics ME) and by means of the permanent magnet 22. According to a further embodiment of the invention, the vibronic module is particularly configured to be installed in the base module in such a manner that its permanent magnet 22 is placed within the chamber 11*, but is nevertheless spaced from the housing wall 11+, viz., in particular in a static (first) installation position E1 specified with respect to an alignment and/or a smallest distance from the electrical coil 12, and/or is held in such a manner that an imaginary longitudinal axis of the first permanent magnet and an imaginary longitudinal axis of the electrical coil 12 are aligned with one another or extend parallel to one another in extension. In particular, the permanent magnet 22 is further configured to form a voice coil, e.g., serving as an electrodynamic vibration exciter, and/or a plunger coil, e.g., serving as an electrodynamic vibration sensor, in installation position E1 together with the electrical coil 12. According to a further embodiment of the invention, the vibronic module M2 and the base module M1 are further configured, in particular also on site, to be assembled without tools and/or disassembled again, in particular non-destructively, in such a manner that the vibronic module can be removed again from the base module M1 non-destructively. Alternatively or in addition, the vibronic module M2 is designed in particular to be replaceable or configured to be able to be removed again, in particular non-destructively, in particular also on site from outside the housing and/or through an (insertion) opening of the (protective) housing 11 provided in the housing wall 11+, and/or the vibronic module M2 is configured, in particular also on site, to be installed in the base module M1, in particular in such a manner that it can be inserted into the chamber 11* from outside the (protective) housing 11 or through the (insertion) opening. This can be done, for example, without having to handle the base module M1 itself or remove it from the respective (process) plant. The aforementioned (slide-in) opening can also, if necessary, be sealed after installation of the vibronic module by means of an appropriate cover—for example, also dust-tight and/or sealed against strong water jets and/or explosion-proof. As a result, it is also possible to easily replace a defective or worn (old) vibronic module on site with an intact, new vibronic module, which may be used only once or only for a specified period (“disposable”). In order to support correct installation of the vibronic module M2 into the base module M1, the vibronic module M2 and base module M1 can each have corresponding guide structures or elements, e.g., corresponding (guide) grooves in one of the two modules (M1, M2) and (guide) springs and/or (guide) pins in the other of the two modules that slide therein during assembly. To further simplify the commissioning of the measurement system, the vibronic module M2 can further comprise at least one identification element 28, e.g., a barcode, QR code, or RFID label (RFID TAG), which relates to or carries identifying information about the vibronic module M2, and/or the base module M1 can have at least one light-emitting semiconductor element 19a, e.g., a light-emitting diode (LED), positioned inside the (protective) housing and connected to the measurement system electronics (into the chamber 11*) for reading the identifying element 28, and/or one or more radio transmitters/receivers (RF transceivers), each positioned within the (protective) housing and connected to the measurement system electronics, and/or photosensors 19b (sensitive to light illuminating the chamber 11*)—for example, viz., one or more CCD photosensors and/or one or more CMOS photosensors.

According to a further embodiment of the invention, the vibronic module M2 has at least one second permanent magnet 24 positioned at a distance from the permanent magnet 22, and in particular cylindrical and/or identical in construction to the permanent magnet 22. Further, the base module M1 accordingly has at least one second electrical coil 14 placed within the chamber 11* of the (protective) housing, e.g., cylindrical and/or designed as an air coil and/or identical in construction to the first electrical coil 12, which (remote from the electrical coil 12) is at least indirectly mechanically connected to the housing wall 11+ and is also electrically connected to the measurement system electronics, and the base module is furthermore configured to receive the vibronic module in such a manner that the permanent magnet 24 is held in a second installation position, in particular with respect to an alignment and/or remote from the first installation position, or that an imaginary longitudinal axis of the permanent magnet 24 and an imaginary longitudinal axis of the electrical coil 14 are aligned with one another or are parallel to one another in extension. In addition, the vibronic module M2 can also have more than two permanent magnets 22, 24 arranged at a distance from one another, thus at least one third permanent magnet 26, and the base module M1 can have more than two electrical coils 12, 14 arranged at a distance from one another within the chamber 11*, thus at least one third air coil 16.

According to a further embodiment of the invention, the vibronic module M2 has at least one (first) tube 31 with a tube wall forming an outer shell surface of the tube 31, e.g., made of a metal or a plastic, and with a lumen 21* enclosed by the same tube wall, and the permanent magnet 22 is fixed to the outside of the tube wall—for example, connected to it by a material bond. As shown schematically in FIG. 1, the at least one tube 31 can be straight at least in sections and/or curved at least in sections, e.g., in such a manner that a central segment of the tube wall extending between a first segment end and a second segment end of the tube wall remote therefrom is designed to be U-shaped or V-shaped, and/or that, as also shown schematically in FIG. 1, the at least one permanent magnet 22 is attached to the outside of the aforementioned central segment. The aforementioned permanent magnet 24 and/or other permanent magnets (26) of the vibronic module M2 can also be attached outside on the central segment, for example. Further, the at least one tube 31 is also intended, inter alia, to be incorporated into the base module M1 in the manner described above and also to be incorporated into the course of a (medium) line for example, a hose line or a plumbing line. In addition, the at least one tube 31 is configured in particular to carry in its lumen a fluid medium flowing, in particular at least temporarily, in a predeterminable direction of flow, e.g., from the aforementioned first segment end to the aforementioned second segment end, e.g., via the aforementioned (medium) line, and to be vibrated in the process; in particular also in such a manner that the at least one tube 31 performs forced bending or resonance oscillations about a static rest position and/or that the at least one permanent magnet 22 is moved relative to the electrical coil 12. Such mechanical vibrations of the at least one (measurement) tube 31 or its central segment can, for example, be excited or maintained by means of the above-mentioned vibration exciter formed by means of the permanent magnet 22 and the coil 12 and/or detected by means of the above-mentioned vibration sensor formed (by means of the permanent magnet 22 and the coil 12), in particular in such a manner that at least one vibration signal representing the same vibrations of the tube 31 or its central segment is provided by the vibration sensor. Not least in order to enable such vibrations of the at least one (measurement) tube 31, in particular of the aforementioned central segment, the vibronic module M2 according to a further embodiment of the invention is further configured to be installed in base module M1 or its (protective) housing 11 in such a way that, as also shown schematically in FIG. 3a, the at least (measurement) tube 31 is placed at least partially, e.g., also completely, within the chamber 11*, nevertheless at least its aforementioned central segment is spaced apart from the housing wall 11+.

As is quite usual with such vibronic modules or vibronic measurement systems formed therewith, the vibronic module M2 can furthermore have at least one second (measurement) tube 32, e.g., also identical in construction and/or function to the first tube, with a tube wall forming an outer shell surface of the second tube, in particular made of a metal or a plastic, and with a lumen enclosed by the same tube wall. In this case, the aforementioned second permanent magnet 24 can, for example, viz., vis-à-vis the permanent magnet 22 fixed to the first tube 31, also be fixed to the second tube, in particular, viz., connected thereto by a material connection; this, for example, also in such a manner that an imaginary longitudinal axis of the permanent magnet 24 and an imaginary longitudinal axis of the permanent magnet 22 are aligned with one another or extend parallel to one another as an extension. The first and second (measurement) tubes 31, 32 can also be fluidically connected to one another by means of a first flow divider on the inlet side and a second flow divider on the outlet side, as is quite common in vibronic measurement systems of the type in question, and may also be integrated into the course of the aforementioned (medium) line during operation of the measurement system. Not least for the case described above in which the vibronic module M2 is formed by means of two tubes (31, 32), the vibronic module M2 can also have more than three permanent magnets arranged at a distance from one another, e.g., at least six permanent magnets in total, and the base module M1 can accordingly have more than three electrical coils arranged at a distance from one another within the chamber 11*, e.g., at least six electrical coils in total—for example, also each designed as air coils.

In order to excite and maintain mechanical vibrations (during the aforementioned measuring mode) of the at least one (measurement) tube 31 or of the vibronic module M2 formed therewith, the measurement system electronics ME are, according to a further embodiment, also configured to provide a first electrical (measurement) driver signal and to introduce it into at least one of the electrical coils (12, 14) of the base module M2, e.g., viz., the coil 12 and/or the aforementioned coil 14, in order to feed electrical power required for the aforementioned mechanical vibrations into the at least one electrical coil; in particular in such a manner that the at least one (first) (measurement) driver signal has 31 an impressed alternating current and/or at least one signal frequency corresponding to a mechanical resonance frequency of the vibronic module M2, in particular its at least one (measurement) tube 31. In the aforementioned case that the base module M1 also comprises at least the second electrical coil 14 in addition to the electrical coil 12, the measurement system electronics ME can further be configured to feed electrical power into the second electrical coil 14 by means of a second electrical (measurement system) driver signal, in particular with an impressed alternating current and/or with a signal frequency corresponding to a mechanical resonance frequency of the vibronic module or its at least one (measurement) tube and/or simultaneously with the (first) (measurement) driver signal.

According to another embodiment of the invention, the measurement system electronics ME are also configured, inter alia, to calculate measured values for the at least one measurement variable to be detected from the medium, based upon the (measurement) voltage or (parameter) measured values determined therefor.

The object of the invention is to improve the checking of modular vibronic measurement systems in such a manner that any malfunctions or defects of the base module and/or the measurement system electronics, not least also signs of wear or aging of the base module or the measurement system electronics which reduce the measuring accuracy of the measurement system as a whole, can be detected as early and reliably as possible and, if necessary, also reported. However, the detection of faults or defects in the base module should not be distorted by defects in the vibronic module or by mobile magnetic field-generating devices, specifically those that do not belong to the base module.

For this purpose, in a test mode when the vibronic module (M2) is absent from the chamber (11*), which test mode in particular precedes and/or follows the measuring mode in time, in particular also when other mobile magnetic field-generating devices are absent, specifically devices not belonging to the base module (M1), the measurement system electronics (ME) of the measurement system according to the invention are, in particular, furthermore configured to perform a check, in particular a (re-)calibration, of the base module (M1) and/or of the measurement system electronics (ME), specifically when the vibronic module (M2) is absent, both to feed a (first) (test) driver signal into the first electrical coil (12) and to capture and evaluate an electrical (test) voltage from the second electrical coil (14), said (test) voltage being in particular inductively coupled from the first electrical coil (13) into the second electrical coil (14), in particular to compare at least one parameter of the (test) voltage, in particular an amplitude and/or a frequency and/or a phase angle and/or a measured value of an inductance with a previously determined reference value and/or with a specified threshold value.

According to another embodiment of the invention, the measurement system electronics ME are also configured to detect and evaluate a first electrical (test) voltage induced, for example, in the first electrical coil 12 and/or in the aforementioned second electrical coil 14, e.g., specifically using the (test) voltage to determine (parameter) measured values for at least one parameter of the (test) voltage, such as an amplitude, a frequency, and/or a phase angle.

Furthermore or alternatively, the measurement system electronics ME can also be configured to calculate measured values for an inductance based upon the (test) voltage or (parameter) measured values determined for this purpose, e.g., in order to take these into account accordingly when checking a functional capability of the measurement system or in order to compare the determined inductance with a previously determined (inductance) reference value and/or one or more threshold values specified for this purpose. Alternatively or additionally, the measurement system electronics ME can, for example, also be configured to compare one or more of the aforementioned (parameter) measured values with one or more (parameter) reference values determined in advance for this purpose and/or one or more threshold values specified for this purpose in order to check the functionality of the measurement system. In the aforementioned case that the base module M1 also comprises at least the electrical coil 14 in addition to the electrical coil 12, the measurement system electronics can also be configured to detect and evaluate an electrical (test) voltage induced in the coil 14, e.g., specifically to calculate (parameter) measured values for the at least one parameter of the (test) voltage and/or a phase difference established between the (test) voltages also on the basis of the second (test) voltage, e.g., in order to calculate measured values for the at least one measurement variable to be detected by the medium. According to a further embodiment of the invention, the measurement system electronics ME are in particular also configured to use a phase difference established between the (test) voltages to obtain measured values for at least one measurement variable, in particular a mass flow, of a flowing fluid, and/or the measurement system electronics are configured to determine and evaluate (parameter) measured values for the aforementioned phase difference, e.g., to compare one or more (parameter) measured values for the phase difference with a previously determined (parameter) reference value and/or one or more threshold values specified for this purpose. Alternatively or in addition, the measurement system electronics may further be configured to determine measured values also for an inductance of the first and/or second electrical coil.

The measurement system electronics ME shown are configured to perform a (re-)calibration of the base module and/or the measurement system electronics ME, especially in the absence of the vibronic module M2 in the chamber 11* (i.e., the vibronic module M2 or other external magnetic field-generating devices are not arranged in the chamber), in particular to feed a (first) (test) driver signal into the first electrical coil 12 in the absence of the vibronic module M2. This is done before the vibronic module M2 is inserted into the chamber 11* or after the vibronic module M2 is removed from the chamber 11*—for example, for the purpose of changing the process control system and/or process medium. For this purpose, the chamber opening of chamber 11* can be closed with a chamber lid, and/or the chamber 11* can be filled with an insertable and removable, magnetically transparent (μ_{γ}, ≤3) packing material.

The measurement system electronics ME are configured to feed electrical power into the first electrical coil by means of a (first) electrical (test) driver signal, in particular with an impressed alternating current. The (test) driver signal has a known characteristic and serves to induce an electrical voltage in a further (second) electrical coil 14 (16). The first electrical coil 12 may, for example, be the driver coil or excitation coil, which is configured to cause the vibronic module or at least one (measurement) tube of the vibronic module to oscillate when the vibronic module is present in the chamber 11*.

The measurement system electronics ME are configured to detect and evaluate a second electrical (test) voltage, which is in particular inductively coupled from the first electrical coil 12 into the second electrical coil 14 or induced in the second electrical coil 14, in particular using the (test) voltage to determine (parameter) measured values for at least one parameter of the (test) voltage, in particular an amplitude and/or a frequency and/or a phase angle and/or a phase difference established between the (test) voltages determined on the second and third electrical coils, and/or to determine measured values for at least one measurement variable of a flowing fluid and/or an inductance. After the specified measurement variable or parameter has been determined via the measurement system electronics ME, (parameter) measured values for the (test) phase difference are determined and evaluated, in particular one or more (parameter) measured values for the (test) phase difference are compared with a previously determined (parameter) reference value and/or one or more threshold values specified for this purpose.

Alternatively or additionally, the measurement system electronics ME are also configured to feed electrical power into the second electrical coil 14 by means of a (second) electrical (test) driver signal, in particular with an impressed alternating current. This is used to check the functionality of the first and/or second electrical coil 12, 14. For this purpose, the measurement system electronics ME are configured to detect and evaluate an electrical (test) voltage, which is, in particular by means of the second coil 14, inductively coupled into the first electrical coil 12 or induced in the first electrical coil 12, in particular using the (test) voltage to determine (parameter) measured values for at least one parameter of the (test) voltage, in particular an amplitude, a frequency, and/or a phase angle, and/or measured values for at least one measurement variable of a flowing fluid medium and/or an inductance of the first electrical coil. According to the embodiment, not only can a magnetic field be generated via the first electrical coil 12, but also a magnetic field generated by the second electrical coil 14 can be measured or detected. For this purpose, the measurement system electronics ME are configured to determine an inductance, in particular of the first or second electrical coil 12, 14 on the basis of the (test) voltage, in particular to compare the determined inductance with a previously determined (inductance) reference value and/or one or more threshold values specified therefor; and/or the measurement system electronics are configured to determine, in particular digital, (parameter) measured values for at least one parameter of the (test) voltage, in particular an amplitude, a frequency, and/or a phase angle, on the basis of the (test) voltage, in particular to compare the (parameter) measured values with a previously determined (parameter) reference value and/or one or more threshold values specified therefor.

Furthermore, the embodiments depicted in FIG. 1 to 4 also depict the variant in which the base module M1 has at least one third electrical coil 16 which is in particular placed within the chamber 11* of the (protective) housing 11, is in particular cylindrical and/or designed as an air coil and/or is identical in construction to the second electrical coil 12, and which, positioned in particular at a distance from the second electrical coil, is in particular at least indirectly mechanically connected to the housing wall 11+; and the third electrical coil 16 is electrically connected to the measurement system electronics ME. The purpose of the third electrical coil 16 is to measure a time-varying magnetic field. For this purpose, the measurement system electronics are configured, during the test mode, to feed electrical power into the third electrical coil 16 by means of a (third) electrical (test) driver signal, in particular with an impressed alternating current, and/or to detect and evaluate an electrical (test) voltage, which is, in particular by means of the first electrical coil 12 and/or the second electrical coil 14, inductively coupled into the third electrical coil 16 or induced in the third electrical coil 16, in particular to determine (parameter) measured values for at least one parameter of the (test) voltage, in particular an amplitude, a frequency, and/or a phase angle and/or an inductance, specifically using the (test) voltage.

Alternatively or additionally, the measurement system electronics ME can be configured to detect and evaluate an electrical (test) voltage, which is, in particular by means of the third electrical coil 16, inductively coupled into the first electrical coil 12 and/or the second electrical coil 14 or induced in the first electrical coil 16 and/or the second electrical coil 14, in particular using the (test) voltage to determine (parameter) measured values for at least one parameter of the (test) voltage, in particular an amplitude, a frequency, and/or a phase angle and/or an inductance of the first electrical coil 12 or the second electrical coil 14.

According to a further embodiment of the invention, the measurement system electronics ME are furthermore also configured to provide the (first) electrical (test) driver signal, the (second) electrical (test) driver signal, and/or the (third) electrical (test) driver signal with a mechanical resonance frequency, in particular first mechanical resonance frequency and/or second mechanical resonance frequency, of the vibronic module corresponding signal frequency.

FIG. 4 shows an alternative embodiment according to the invention in which the first, second, or third electrical coil 12, 14, 16 is arranged in the measurement system electronics ME or is part of the measurement system electronics ME. This means that the first, second, or third electrical coil 12, 14, 16 can be arranged on a circuit board of the measurement system electronics ME. In this case, the first, second, or third electrical coil 12, 14, 16 or one of the three coils 12, 14, 16 is provided in addition to the drive coil and the at least one sensor coil or the at least two sensor coils (per tube). According to the embodiment, the first, second, or third electrical coil 12, 14, 16 is a diagnostic coil which is designed and arranged such that the generated magnetic field induces an electrical voltage in at least one further electrical coil and preferably in all further electrical coils of the base module during operation.

Alternatively or additionally, the diagnostic coil arranged in or on the measurement system electronics ME can be configured to monitor the magnetic field generated by the first coil 12. In this case, the measurement system electronics ME are configured to detect a voltage induced at the diagnostic coil and use this for the (re-)calibration.

Alternatively, the third electrical coil can also be replaced by a magnetic field sensor different from a coil, in particular a Hall sensor, which is configured 77 to generate a magnetic field generated by the first, second, and/or third electrical coil 12, 14, 16.

In one embodiment, the third electrical coil 16 can also be designed to be spatially displaceable in order to bring it closer to the electrical coil to be tested.

In the illustrated embodiments, the first, second, and/or third electrical coils 12, 14, 16 are always arranged on a common chamber surface of the chamber 11*. However, the coils 12, 14, 16 can also be arranged on different chamber surfaces. For example, the second and/or the third coil 14 (16) can be arranged on a chamber surface opposite the first coil 12, i.e., the first coil 12 is separated from the second and/or third coil 14 (16) by the receiving volume of the chamber 11*.

1-20. (canceled)

21. A modular measurement system, being a modular Coriolis mass flow meter, for measuring at least one measurement variable of a fluid medium, the measurement system comprising:
a measurement system electronics; and
a base module, comprising:
a housing including at least one chamber at least partially enclosed by a housing wall; and
a first electrical coil disposed within the chamber of the housing, at least indirectly mechanically connected to the housing wall, and electrically connected to the measurement system electronics; and
a second electrical coil disposed within the chamber, embodied as an air coil and/or identical in construction to the first electrical coil, arranged at a first distance from the first electrical coil, and at least indirectly mechanically connected to the housing wall, wherein the second electrical coil is electrically connected to the measurement system electronics,
wherein the base module is configured to receive a vibronic module of the measurement system in the chamber and to be connected thereto in a mechanically fixed, yet detachable manner, so as to form a measuring sensor of a vibration type or a vibronic measurement system and/or such that the vibronic module is locked in the base module or cannot be moved,
wherein, in a measuring mode when the vibronic module is present in the chamber, the measurement system electronics are configured to supply a measurement driver signal to the first electrical coil, which excites vibrations of the vibronic module, and to capture and evaluate a measurement voltage from the second electrical coil, induced in the second electrical coil by the vibrations of the vibronic module, to determine measurement values for the at least one measurement variable, and
wherein, in a test mode when the vibronic module is absent from the chamber, which test mode precedes and/or follows the measuring mode in time, the measurement system electronics are configured to perform a check or a (re-)calibration of the base module and/or of the measurement system electronics by:
supplying a first test driver signal to the first electrical coil; and
capturing and evaluating a test voltage from the second electrical coil, the test voltage being inductively coupled from the first electrical coil into the second electrical coil, wherein the evaluating includes comparing at least one parameter of said test voltage with a previously determined reference value and/or with a specified threshold value, wherein the at least one parameter is at least one of an amplitude, a frequency, a phase angle, and a measured value of an inductance,
wherein, in the test mode, other magnetic field-generating devices not belonging to the base module are further absent from the chamber.

22. The modular measurement system according to claim 21, wherein the measurement system electronics are configured to supply electrical power into the first electrical coil via the measurement driver signal and/or the first test driver signal with an impressed alternating current.

23. The modular measurement system according to claim 21, wherein the measurement system electronics are configured to supply the first test driver signal with at least two different frequencies of a resonance frequency of the protective housing, a nominal resonance frequency of the vibronic module, and a mains frequency.

24. The modular measurement system according to claim 21, wherein, in the test mode, the measurement system electronics are configured to supply electrical power into the second electrical coil via a second test driver signal with an impressed alternating current.

25. The modular measurement system according to claim 24, wherein the measurement system electronics are further configured, in the test mode, to detect and evaluate a test voltage, which is inductively coupled into the first electrical coil or induced in the first electrical coil by the second electrical coil, wherein to evaluate includes to determine at least one parameter of said test voltage and to compare the at least one parameter with the previously determined reference value and/or with the specified threshold value, wherein the at least one parameter of said test voltage is at least one of an amplitude, a frequency, a phase angle, and a measured value of an inductance.

26. The modular measurement system according to claim 21, wherein the measurement system electronics are configured to determine an inductance of the first electrical coil based on the test voltage and to compare the determined inductance with a previously determined inductance reference value and/or one or more threshold values specified therefor; and/or
wherein the measurement system electronics are configured to determine measured values for the at least one parameter of the test voltage using the test voltage and to compare the measured values with a previously determined reference value and/or one or more threshold values specified therefor, wherein the at least one parameter of said test voltage is at least one of an amplitude, a frequency, and a phase angle.

27. The modular measurement system according to claim 24, wherein the base module comprises a third electrical coil disposed within the chamber, embodied as an air coil and/or identical in construction to the second electrical coil, arranged at a second distance from the second electrical coil, and at least indirectly mechanically connected to the housing wall,
wherein the third electrical coil is electrically connected to the measurement system electronics.

28. The modular measurement system according to claim 27, wherein the measurement system electronics are configured to supply electrical power to the third electrical coil via a third test driver signal with an impressed alternating current.

29. The modular measurement system according to claim 27, wherein the measurement system electronics are configured to detect and evaluate a test voltage, which is inductively coupled into the third electrical coil or induced in the third electrical coil by the first electrical coil and/or the second electrical coil, and to determine at least one parameter of said test voltage using said test voltage, wherein the at least one parameter is at least one of an amplitude, a frequency, a phase angle, and an inductance.

30. The modular measurement system according to claim 27, wherein the measurement system electronics are configured to detect and evaluate a test voltage from the first electrical coil and/or the second electrical coil, which test voltage is inductively coupled into the first electrical coil and/or the second electrical coil or induced in the first electrical coil and/or the second electrical coil by the third electrical coil, and to determine at least one parameter of said test voltage using said test voltage, wherein the at least one parameter is at least one of an amplitude, a frequency, a phase angle, and an inductance.

31. The modular measurement system according to claim 27, wherein the measurement system electronics are configured to detect and evaluate test voltages, which are inductively coupled into the second electrical coil and the third electrical coil or induced in the second electrical coil and in the third electrical coil by the first electrical coil, and using said test voltages for at least one parameter of said test voltages to determine in each case an amplitude, a frequency, a phase angle, an inductance, and/or a phase difference between the test voltage detected at the second coil and the test voltage detected at the third coil.

32. The modular measurement system according to claim 28, wherein the measurement system electronics are configured to provide the first test driver signal, the second test driver signal, and/or the third test driver signal with a first mechanical resonance frequency and/or a second mechanical resonance frequency of the vibronic module corresponding signal frequency.

33. The modular measurement system according to claim 21, wherein the vibronic module includes at least one permanent magnet,
wherein the vibronic module is configured to be installed in the base module such that the at least one permanent magnet is disposed within the chamber, spaced apart from the housing wall and held in a predetermined and/or static installation position with respect to an orientation and/or a smallest distance from the first electrical coil, and/or held with the static (first) installation position and/or such that an imaginary longitudinal axis of the at least one permanent magnet and an imaginary longitudinal axis of the first electrical coil are aligned with each other or extend parallel to each other.

34. The modular measurement system according to claim 27, wherein the third electrical coil is part of the measurement system electronics.

35. The modular measurement system according to claim 27, wherein the third electrical coil is adapted to be spatially displaceable.

36. The modular measurement system according to claim 21, wherein the measurement system electronics are configured to determine and evaluate measured values for a coil current or variables dependent thereon, wherein to evaluate includes to compare one or more measured values for the coil current or variables dependent thereon with a previously determined coil current reference value and/or one or more coil current threshold values specified therefor.

37. The modular measurement system according to claim 21, wherein the measurement system electronics are configured to determine and evaluate measured values for a signal strength of the first test driver signal and to compare one or more measured values for the signal strength of the first test driver signal with a previously determined signal strength reference value and/or one or more signal strength threshold values specified therefor.

38. The modular measurement system according to claim 21, wherein the measurement system electronics are configured to determine and evaluate a signal curve of the measurement driver signal and/or the first test driver signal over time.

39. The modular measurement system according to claim 21, wherein the measurement system electronics are configured to perform the check in the test mode in the absence of a test module or other magnetic field-generating devices not belonging to the base module to both to feed the first test driver signal into the first electrical coil and to detect and evaluate the test voltage from the second electrical coil, which test voltage is inductively coupled from the first electrical coil into the second electrical coil, wherein to evaluate includes to compare the at least one parameter of the test voltage.

40. A method for commissioning and/or checking a vibronic measurement system, being a modular Coriolis mass flow meter, which measurement system comprises:
a measurement system electronics;
a base module including a protective housing including at least one chamber at least partially enclosed by a housing wall;
a first electrical coil and a second electrical coil, each disposed within the at least one chamber of the protective housing, at least indirectly mechanically connected to the housing wall, and electrically connected to the measurement system electronics; and
a vibronic module according to claim 33;
wherein the base module is configured to receive the vibronic module and to be connected thereto in a mechanically fixed, yet detachable manner, so as to form a measuring sensor of a vibration type or a vibronic measurement system and/or such that the vibronic module is not movable or is locked in the base module;
the method comprising:
checking or (re-)calibrating the base module and/or the measurement system electronics during a test mode using the measurement system electronics, in the absence of the vibronic module in the chamber or any other mobile magnetic field generating devices not belonging to the base module, by:
supplying a first test driver signal into the first electrical coil; and
detecting and evaluating a test voltage from the second electrical coil, which test voltage is inductively coupled from the first electrical coil into the second electrical coil, wherein the evaluating includes comparing at least one parameter of the test voltage with a previously determined reference value and/or with a specified threshold value, wherein the at least one parameter is at least one of an amplitude, a frequency, a phase angle, and a measured value of the self-inductance;
inserting the vibronic module into the base module so as to form a vibration-type measuring sensor or the vibronic measurement system; and
determining measured values for at least one measurement variable of a fluid medium during a measuring mode by supplying a measurement driver signal to the first electrical coil to excite vibrations of the vibronic module and detecting a measurement voltage from the second electrical coil, which measurement voltage is induced in the second electrical coil by vibrations of the vibronic module.
